(19) United States
(12) Patent Application Publication
(10) Pub. No.: US 2004/0251338 A1
(43) Pub. Date: Dec. 16, 2004

(54) Process and device for beating pulps between two beating surfaces

(76) Inventor: Helmuth Gabl, Graz (AT)

Correspondence Address: ALIX YALE & RISTAS LLP, 750 MAIN STREET, SUITE 1400, HARTFORD, CT, 06103, US

(21) Appl. No.: 10/807,843

(22) Filed: Mar. 24, 2004

(30) Foreign Application Priority Data
Mar. 26, 2003 (AT) A 477/2003

(51) Int. Cl. B27J 1/00

(52) U.S. Cl. 241/28

(57) ABSTRACT

The invention relates to a process for beating pulps between two beating surfaces. In particular, the invention includes the differential speed of the beating surfaces being in the region of −5 m/s and +12 m/s, where it is an advantage if the differential speed is virtually zero. The invention also relates to a device for implementing the process. The device may include rolls, which are provided as beating elements.

### BACKGROUND OF THE INVENTION

The invention relates to a process for beating pulps between two beating surfaces, as well as a device for implementing the process.

The best possible utilisation of the strength properties of pulps of all kinds (such as wood pulps, annual plants, animal fibres) permits lower-cost production of paper, leather, etc. In order to make use of this potential, the pulps must be treated in a so-called refining process so that the bonding properties of the fibres can be developed.

Traditionally, this process was performed in so-called “hollanders”, large cylinder machines for batch operation. In view of the low throughput and high specific energy consumption, these machines were replaced by continuous refiners.

Currently, refiners are built as confronting disc, conical, or cylindrical models. The disadvantage of the disc, conical and cylindrical designs built to date is the relative speed along the refining zone, which requires relatively high no-load power—depending on the refiner model. At particularly low throughputs, however, there may be difficulties in centering the rotor in the setting direction, depending on the refiner model.

A further significant disadvantage with, e.g., the conical refiner is the poor pumping efficiency as the centrifugal force does not act in the direction of pulp flow. Throughput problems result and later, the grooves have to be enlarged, which leads to a reduction in the edge length.

Further disadvantages are the considerable forces occurring and relative displacement of the bars to one another during setting, the need for a sturdy structure in view of the high bearing, and the difficulties involved in changing the plate segments.

Although many of these disadvantages can be avoided with a cylinder refiner, a conventional cylinder refiner still bears the risk of throughput problems similar to those with the conical refiner. This problem can be avoided by using a feed with integrated pressure build-up.

In spite of a significant drop in energy consumption during no-load operation with the cylinder refiner—approximately 40 to 50% lower—unfortunately, the strength potentials stored in the pulps are not activated sufficiently in relation to the overall energy input, nor are they utilized adequately in production of market pulp.

In conventional refining of pulps used to date, additional undesirable phenomena occur, e.g., in paper production, such as a sharp rise in dewatering resistance (increase in Schopper-Riegler units) and loss of optical properties, etc. This reduces the production capacity on the one hand, and on the other it requires significantly higher energy inputs for dewatering the pulp web, as well as higher drying capacities.

In conventional refining, the pulps are pumped at low consistency (<10%) or conveyed at medium to high consistency (10%>c>35%) by screw conveyors, displacement pumps or MC-pumps into the gap between rapidly rotating refining elements, consisting of rotors and stators with differential speeds of approximately v=15 to 70 m/sec. These high differential speeds are needed to rough up the surface and compress the fibre material, while pressing the pulp at the same time. A large part of the energy applied is lost in the form of friction heat. According to the literature, only some 3 to 10% of the energy input is used to treat the fibres.

### SUMMARY OF THE INVENTION

The present invention is intended to alleviate or avoid the disadvantages described above.

The invention is directed to a process for beating pulps between two beating surfaces, wherein the differential speed of the beating surfaces is in the range of −5 m/s and +12 m/s. It is an advantage if the differential speed is virtually zero. Differential speed is determined in relation to one of the surfaces. If the surface is moving, e.g. a surface on a rotating roll, then in the case of negative rates the other surface is slower, and in the case of positive rates the other surface is moving faster than the reference surface. This provides a significant economic advantage due to the reduction in no-load power by up to approximately 90%. The low differential speed also permits targeted application of pressing forces to the individual or the bundled fibres, which results in compression beating. It is true that the substantial technological advantages of compression beating were utilized when the first beating/pounding plants were used, however these advantages could never be integrated into continuous process stages for industrial purposes.

An advantageous further development of the invention is characterised by the pulp being fed to the beating machine in the form of a pulp web. The advantage of this method is that very high capacities undergo initial compression beating in a very even process stage directly at the end of the pulp production process, at low cost and targeted to the required technology. This permits a significant reduction in the required beating effort if the pulp is to be further treated in conventional pulp treatment plants. Thus, there is no need to extend or also improve the beating plants in order to obtain higher strengths.

According to a further variant of the invention, two or more beating stages are carried out one after the other. The advantage of serial connection is shown by increased utilization of the fibre strength potential available.

A favourable configuration of the invention is characterised by the pulp being distributed evenly over the beating zone. The large surface area thus obtained, together with very even fibre distribution in cross-direction, longitudinal and Z directions, leads to a high fibre hit probability with the advantage of even fibre treatment, while utilizing the strength potential of as many individual fibres as possible, i.e., use of the overall strength level is particularly extensive.

According to an advantageous further development of the invention, the pulp is fed to the beating machine directly from the thickener. The technical and economical advantages are similar to those already mentioned. A further advantage is that the capital investments can be reduced as there is no need for large chests, pipework, pumps, or process control and instrumentation; thus the process can be greatly simplified.

The invention also relates to a device for implementing the process. It is characterised by rolls being provided as beating element. The advantage of this is the continuous operating mode.

A particularly favourable configuration of the invention is characterised by the rolls being driven at or otherwise having the same speed. The advantage lies in the very low energy input for frictional force, with intensive loading of adjustable pressing forces. The low frictional force released by the virtually non-existent relative speed reduces the energy consumption for web transport and compression beating to virtually zero.

According to a favourable further development of the invention, roll pairs are provided with an extended beating gap, where the roll(s) may have a shoe-type or beam-type support in order to create the extended gap. Due to this extended beating gap, the forces can engage more gently on the one hand, while prolonging the retention period at the same time. A favourable configuration of the invention is characterised by the rolls having spikes. The spikes increase the “surface area of the plate segments” and permit better penetration and treatment of the fibre material.

A favourable further development of the invention is characterised by the rolls having features such as fluting or grooves, where the fluting or grooves can run in circumferential direction or at an angle to the roll axis. Enlargement of the roll surface by fluting or grooves has the advantage of increasing the number of individual fibres reached and thus, treated.

An advantageous configuration of the invention is characterised by the fluting or grooves engaging one another. If the rolls are shaped such as to allow them to engage one another—positive locking—there is no differential speed. The entire energy input is reduced or converted into a form of compression beating. This leads to maximum utilisation of the raw material in terms of developing the strength, while keeping the rise in dewatering resistance as low as possible.

According to a favourable configuration of the invention, the fluting or grooves are trapezoidal in shape.

According to an advantageous further development of the invention, the base of the fluting or grooves may have dewatering recesses. Residual water—e.g., at low inlet consistencies—drains into the recesses and can be extracted from these recesses by suction or by centrifugal force. The advantage here is that higher solids concentrations occur in the beating zone. Depending on process control, a necessary process stage can be omitted, or higher final drynesses obtained. Thus, the energy consumption of a subsequent thickening stage or thermal drying can be reduced.

A favourable configuration of the invention is characterised by the rolls having their own drive.

According to an advantageous configuration of the invention, a separate web guide feeds the pulp to a point directly in front of the beating zone, thus no preliminary units are needed. The advantage here lies in the reduced investment costs and space requirement.

It has proved advantageous to feed the pulp to the beating machine directly from a thickener, then there is no need for an additional machine to provide even distribution of the fibre material as a web.

In an advantageous embodiment of the invention, a moving weave of wire, rubber or similar material is provided that is wrapped round at least one roll or which is guided over deflection rolls and can be pressure-loaded against at least one roll.

Roll speed, roll gap length, roll gap, differential speed, pressing force, surface structure and material properties determine the duration for which the beating forces act on the beating material. The basic principle of so-called “Extended Refining” or “Extended Retention Refining” (ERR) can also be used for the beating application and allows the retention/beating time to be extended to many times its original length.

In order to increase the beating effect, one or more rolls roll nips can be arranged in series. These arrangements can be used with both low-consistency and to high-consistency beating.

In addition to large roll diameters, any type of shoe or beam support is also suitable for creating an extended beating gap. Several of these extended nips can be arranged in series and at short distances from one another. These rolls can also use a flexible sub-structure with hydraulic-pneumatic support to improve and increase the evenness of beating. The supporting shoe can be guided with supporting elements which have lubrication holes, e.g. holes, sintered metal inserts to allow the lubricant (water, air, oil, etc.) to pass through and thus facilitate the sliding movement.

A fundamental aspect in the new method of treating pulps to increase strength properties by making use of the potential available in the fibres is the shaping of the roll surface. The roll surface can be smooth on one or both sides, have spikes, or fluting. The fluting or the grooves, if present, can be oriented in circumferential direction or at an angle of up to 90° to the direction of the roll axis.

The rolls may have circumferential fluting that mesh into one another. The depths of the fluting are selected according to the type of pulp, the thickness of the web fleece, and the solids content. Trapezoidal recesses with a groove depth of 1 to 25 mm are an advantage. The base of the groove may also have dewatering recesses—e.g. additional holes to drain off water, similar to the suction roll principle in the press section of a paper machine.

The grooves can be milled, ground, etched, or eroded into the roll body or may be created by raising parts of the roll surface. A simple, raised groove pattern can be achieved by winding wire round the roll, thus providing different geometries depending on the wire shape selected.

Instead of a second press roll, the roll body can be enclosed in a moving weave of wire, rubber, etc., with additional pressure loading being applied to create a compression effect for a longer period. To achieve maximum fibre compression, rolls with small diameters are preferred because of the low pressing force.

As an alternative, a woven belt made of wire or rubber can be pressed against the roll or may extend over several rolls.

The circumferential speed of the rolls—or any differential speed that may be set—depends, among other things, on the roll surface.

In order to set the speeds—possibly low differential speeds—the rolls are driven.

It is a particular advantage to have rolls with grooves and elevations at regular intervals in circumferential direction, similar to the fluted rolls used for corrugating.

This fluting runs parallel or at an angle of about 0° to about 45° to the roll axis (helical gearing). The fluting may be discontinued in circumferential direction, which permits slight dewatering for a brief period, particularly at low pulp consistencies. This has a beneficial effect on beating.

The flank shaping of the fluting may also have slight, so-called “secondary fluting”.

Since beating is based on intensive compression, a basic beating element structure similar to a perforated roll is suitable. In a surface structure with perforations, additional dewatering takes place during the beating process. The perforations can be made, for example, as blind drill holes.

Further variants are surface designs such as those currently used in refiners. In this case, the rolls can be operated at different speeds because the beating elements do not engage one another. Thus, the ratio of shearing forces to pressing forces can be varied.

The surfaces of the rolls may be manufactured from very hard materials in order to obtain a long service life.

The beating elements on the roll body can be attached in segments or also as individual and removable elements, manufactured from, for example, high-grade steel or ceramic material.

For reasons of wear, steel alloys such as those currently used in refiners are suitable. All materials can also be surface-alloyed.

For special applications, different materials can be combined in manufacturing press rolls.

By using materials with different hardnesses or different materials, the beating zone can be enlarged, which in turn is beneficial to the compression-beating process targeted.

The no-load drive power drops with this machine concept to approximately 3-5% of conventional refining plants, while the overall energy required to obtain the same strengths drops to below 50%. In addition, the opacity and other optical properties are retained to a greater extent than in conventional refining.

The capacity of these beating plants is a function of the working width and the area-related mass of the preceding distribution machine. The working widths of the beating machines can be adapted easily to a specific output by changing the pulp distribution width.

The untreated web fed into the beating gap has a weight of 100 to 1500 g/m² in most cases. This applies both to LC (low-consistency) and to MC (medium-consistency), as well as to HC (high-consistency) beating processes. The area-related mass is adapted to suit the raw material in each case.

The machine type employed may be varied, depending on the pulp consistency to be refined.

For example, with feed in the low-consistency range, the pulp enters the beating zone on a separate web-forming guide mechanism that extends to a point immediately upstream of the beating zone. The objective is to obtain even distribution of the beating material into the beating zone. Here, the pulp is not thickened—although it could be brought to a higher consistency level—but merely distributed evenly over the beating zone.

It is an advantage if beating takes place immediately after a thickener, e.g. when beating recycled fibres. The fibres to be treated can be fed directly from the thickener to the beating machine. This applies particularly to pulp treatment at higher consistencies.

As soon as higher consistencies permit the web to run without support, thanks to the initial web strength being improved beforehand, this form of treatment is referred to as high-consistency beating. The consistency range can vary to a very large extent (preferably 25% to 65% dryness—limited only by the mechanical dewaterability) and depends largely on the raw material, the mass of the pulp web in relation to its surface area, and on what pre-treatment the web has undergone. Hardwood recycled grades require a higher consistency than softwood pulps.

In the event of low-consistency beating, the pulp is fed through a nip and compressed mainly by targeted pressure-loading of the rolls and by controlling the roll speeds. In this process, the inner and outer surfaces of the fibres are enlarged and activated for bonding.

It is also fundamental to this method to fill the beating zone evenly so that the fibre material is given the same treatment over the entire web width.

Similar to the design for low-consistency beating, the roll surfaces are fluted or have spikes, or they can have a grooved-corrugating profile similar to the rolls used to make the corrugating in corrugated board, etc.

### BRIEF DESCRIPTION OF THE DRAWING

The invention will be described using the examples in the drawings, where

FIG. 1 contains a schematic diagram of the invention;

FIG. 2 shows a schematic side view of a variant of the invention;

FIG. 3 provides a schematic side view of a further variant of the invention;

FIG. 4 provides a schematic side view of another variant of the invention;

FIG. 5 shows an implementation of the invention; and

FIGS. 6 and 7 show further variants of the invention.

### DESCRIPTION OF THE PREFERRED EMBODIMENTS

Briefly stated, the invention in a preferred form is a refiner and a process utilizing compression beating for processing pulp. FIG. 1 shows a diagram of a device in accordance with one embodiment of the invention. The beating plant 1 comprises one roll 2 and a second roll 3, which are driven by a first and second motor, 4 and 5 respectively. The first roll 2 and the second roll 3 should run preferably at the same speed so that the material being beaten, here in the form of a web 6, is only subjected to pressing forces, but not to shearing forces.

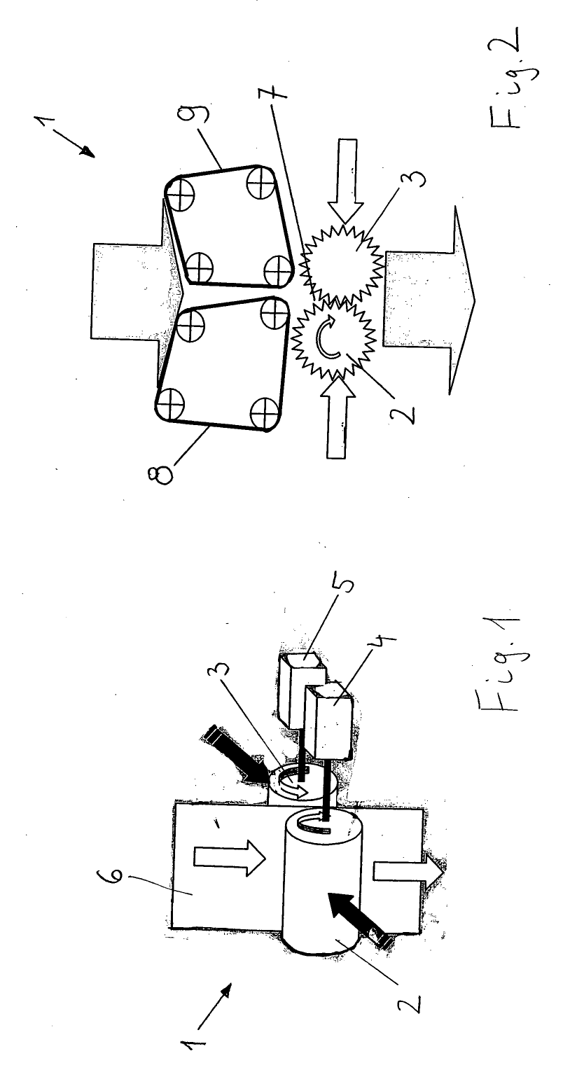

In FIG. 2, a side view of a variant of the invention is shown. The first roll 2 and second roll 3 of the beating plant 1 are illustrated with spikes, however these rolls could also have appropriate grooves or fluting. Both roll 2 and roll 3 are pressed against each other. The unrefined pulp is carried on suitable belts, for example, wires 8 and 9 to a point directly upstream of the beating gap 7. The gap may then be fed between the roll 2 and roll 3 such that it is distributed evenly over the beating zone.

FIG. 3 shows another embodiment of the invention wherein there are two beating devices 1, 1′. The first beating device 1 has a first beating roll 2 and a second beating roll 3 and the second beating device 1′ has a first beating roll 2′ and a second beating roll 3′. The first beating device 1 and second beating device 1′ are, for example, arranged one behind the other.

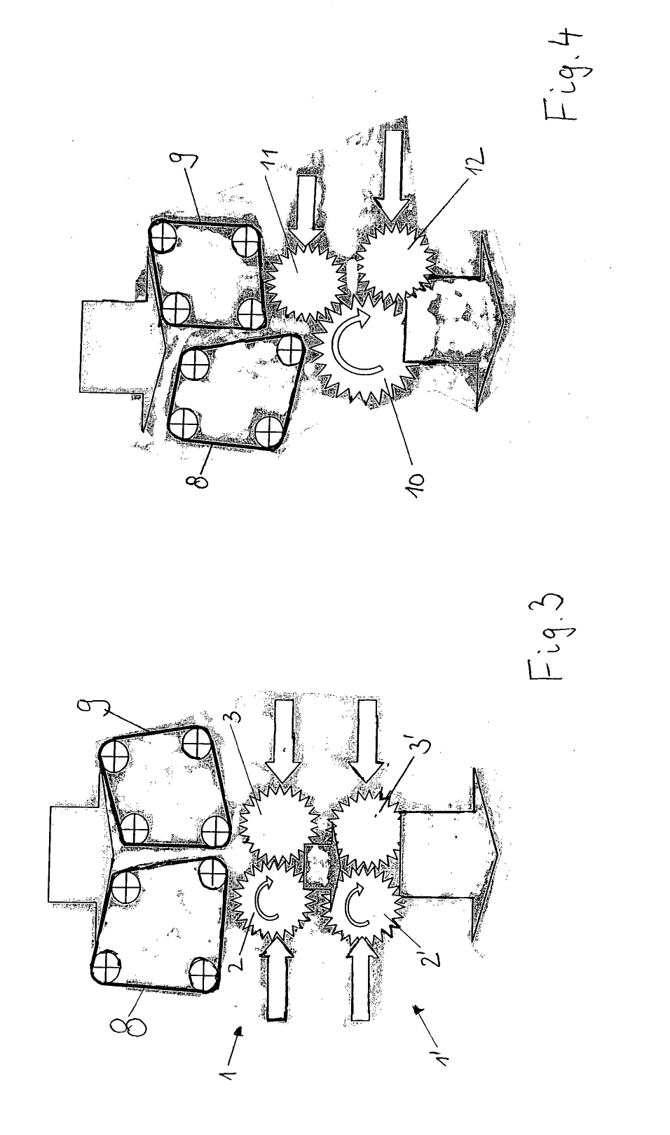

FIG. 4 shows an embodiment of the invention having a central beating roll 10. The central beating roll 10 is positioned so as to absorb the forces from a first roll 11 and a second roll 12. An advantage, among others, of this arrangement is the compact structure. With this configuration, all rolls can be operated at the same surface speed. Depending on the quality requirements of the market pulp, however, the two outer rolls may have different pressing forces, different surface structures, and/or different, adjustable relative speeds.

In an embodiment of the invention as illustratively shown in FIG. 5, a moving weave 13′ may be present. The moving weave 13′ is made of a material such as wire, rubber, or similar materials attached, for example, by being wrapped round the roll 2. This arrangement allows the pulp to be compressed for a longer period.

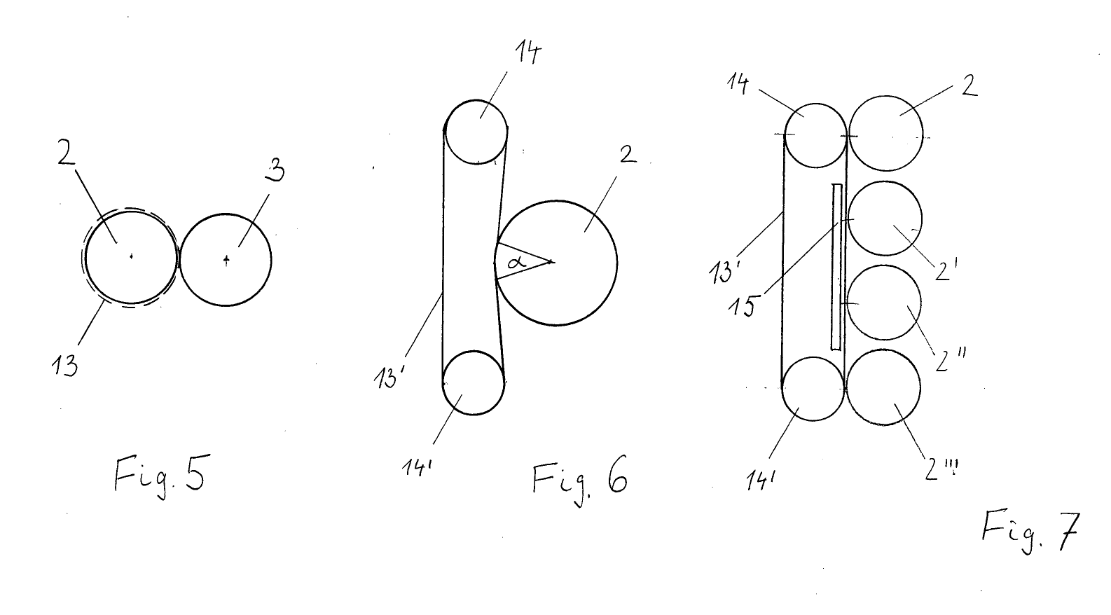

In another embodiment of the invention as illustratively shown in FIG. 6, a moving weave 13′ of wire, rubber, or similar material is provided and guided over, for example, deflection roll 14 and a second deflection roll 14′. The angle of wrap of the roll 2 may be anywhere between about 0° (lumped pressure-loading) and about approximately 350°.

In yet another embodiment of the invention as illustratively shown in FIG. 7, for example, a first moving weave 13′ of wire, rubber, or similar material is guided over deflection rolls 14, 14′. The moving weave 13′ is pressed against several rolls 2, 2′, 2″, 2′″. Pressure loading is applied between the deflection rolls 14, 14′ and the end rolls 2, 2′″, and augmented with a supporting element 15 pressing against the rolls 2′, 2″.

While the preferred embodiments of the invention have been set forth for the purposes of illustration, the foregoing description should not be deemed a limitation of the invention. Accordingly, various modifications, adaptations and alternatives may occur to one skilled in the art without departing from the spirit and scope of the claims.

1. A process for continuous compression refining of pulp comprising:
forming a continuous pulp flow;
directing the continuous pulp flow to a refining zone having compressive beating surfaces, said beating surfaces having a differential speed of about −5 m/s to about +12 m/s;
refining the continuous pulp flow in the refining zone; and
discharging the refined pulp from the refining zone.

2. The process for compression refining of pulp of claim 1, wherein the differential speed of the beating surfaces is about 0 m/s.

3. The process for compression refining of pulp of claim 1, wherein the continuous pulp flow is in the form of a pulp web.

4. The process for compression refining of pulp of claim 1, further comprising the steps of:
directing the discharged refined pulp at least one additional refining zone having compressive beating surfaces, said beating surfaces having a differential speed of about −5 m/s to about +12 m/s;
refining the discharged refined pulp flow in the refining zone; and
discharging the refined pulp from the at least one additional refining zone.

5. The process for compression refining of pulp of claim 1, wherein the refining zone has an effective width and the directing of the continuous pulp flow distributes the pulp evenly over the refining zone effective width.

6. The process for compression refining of pulp of claim 1, wherein the forming of a continuous pulp flow includes discharging pulp directly from a thickener and the directing of the pulp flow delivers the pulp flow directly from the thickener to the refining zone.

7. A compressive pulp beating refiner comprising:
a pulp in-feed;
a refining zone for receiving the in-fed pulp, having two beating surfaces defined by confronting rolls; and
a pulp outlet from the refining zone.

8. The compressive pulp beating refiner of claim 7, wherein said confronting rolls rotate at substantially the same rate.

9. The compressive pulp beating refiner of claim 7, wherein said confronting rotating rolls rotate such that the beating surfaces of the rolls move at substantially the same speed.

10. The compressive pulp beating refiner of claim 7, wherein said confronting rolls rotate such that the beating surfaces of the rolls move at substantially the same speed while the confronting rolls rotate at a different rate.

11. The compressive pulp beating refiner of claim 7, wherein there are pairs of confronting rolls having an extended beating gap.

12. The compressive pulp beating refiner of claim 11, wherein each roll utilizes a shoe-type support to form the extended gap.

13. The compressive pulp beating refiner of claim 11, wherein each roll utilizes a beam-type support to form the extended gap.

14. The compressive pulp beating refiner of claim 7, wherein both of said confronting rolls rotate and have interengagable spikes.

15. The compressive pulp beating refiner of claim 7, wherein both of said confronting rolls rotate and have fluting or grooves.

16. The compressive pulp beating refiner of claim 15, wherein said fluting or grooves extend in circumferential direction.

17. The compressive pulp beating refiner of claim 16, wherein said fluting or grooves angularly traverse a roll axis.

18. The compressive pulp beating refiner of claim 15, wherein said fluting or grooves engage one another.

19. The compressive pulp beating refiner of claim 15, wherein said fluting or grooves is trapezoidal in shape.

20. The compressive pulp beating refiner of claim 15, wherein said fluting or grooves have a base and the base has dewatering recesses.

21. The compressive pulp beating refiner of claim 15, wherein at least one roll surface has a pre-defined roughness.

22. The compressive pulp beating refiner of claim 7, wherein the in-feed includes a web guide feeding the pulp to a point directly in front of the beating zone.

23. The compressive pulp beating refiner of claim 7, wherein the in-feed is operatively connected to a pulp thickener.

24. The compressive pulp beating refiner of claim 7, wherein at least one beating surface is associated with a moving weave.

25. The compressive pulp beating refiner of claim 24, wherein the moving weave is wrapped round at least one roll.

26. The compressive pulp beating refiner of claim 24, wherein the moving weave is guided over deflection rolls and is pressure-loaded against at least one roll.

27. A compressive pulp beating refiner comprising:
a pulp in-feed;
a refining zone between two relatively moving beating surfaces, said beating surfaces having a differential speed in the range of about −5 m/s to about +12 m/s; and
a pulp outlet.
